(19) United States
(12) Patent Application Publication
(10) Pub. No.: US 2015/0026091 A1
(43) Pub. Date: Jan. 22, 2015

(54) METHODS AND SYSTEMS FOR PROVIDING DATA PACKAGES

(71) Applicant: Xerox Corporation, Norwalk, CT (US)

(72) Inventors: Kovendhan Ponnavaikko, Chennai (IN); Rinku Gajera, Bangalore (IN); Nischal M Piratla, Fremont, CA (US)

(73) Assignee: Xerox Corporation, Norwalk, CT (US)

(21) Appl. No.: 13/947,203

(22) Filed: Jul. 22, 2013

(51) Int. Cl. G06Q 30/00

(52) U.S. Cl. CPC G06Q 30/01
USPC 705/342

(57) ABSTRACT

Some embodiments relate to a method and system for creating a data package for one or more consumer services. The method includes displaying a number of consumer services through an information-retrieving interface to a user, and receiving a selection of at least one consumer service from the user. The method then searches for information corresponding to the at least one selected consumer service in a database. The information may include workflow information, an application procedure for the selected consumer service, form(s), supporting document(s), and experiences of other users. The method also includes creating a data package based on the results of the searching. Furthermore, the method includes presenting the data package associated with the at least one selected consumer service to the user.

### TECHNICAL FIELD

The presently disclosed embodiments relate to information systems, and more particularly to creating and presenting information or data packages for various consumer services to users.

### BACKGROUND

It is common for people to be placed in situations in which they need to fill out forms, such as applications for a bank account, credit card, passport, Visa, driver's license, telephone services, cable or satellite television services, educational services, and so forth. In many countries, such as emerging markets, the application processes (and workflows related thereto) for most consumer services are still heavily paper based, and customers are required to fill out several forms. The set of forms used in the application processes can be different based on the customers' demographics. Further, the forms may need to be revised over time as requirements change. The customers may also need to attach or provide several supporting documents while filling out the forms and to complete the application process. Once again, based on the service(s) requested and the demographics, the set of supporting documents may differ, which can confuse the customers about an application or workflow process. This problem can be aggravated (and in some cases significantly) by various factors, such as a lack of clear documentation (especially when widespread), lack of customer service(s) (especially when non-existent), untimely customer services, frequently change in instructions and procedures without communication, etc.

As a result, preparation of an application for a consumer, such as in the context of providing customer service(s), can be extremely complicated. This problem exists across a wide socio-economic range, and involves people of different literacy levels (from literates to illiterates), different residential locales (from urban to rural areas), etc. Multiple visits to a service provider's offices for purposes relating to a limited number of issues (and in some cases a single issue) a are quite common, which is particularly inconvenient for applicants located in remote rural areas.

### SUMMARY

Thus, it may be beneficial to provide a convenient and manageable way of helping users or consumers in the application process of various consumer services.

Some embodiments provide a method for creating a data package for one or more consumer services. The method includes displaying a number of consumer services through an information-retrieving interface to a user. The method also includes receiving a selection of at least one consumer service from the user. The method further includes searching for information corresponding to the selected consumer service in a database. The information may include workflow information, application procedure(s) for the selected consumer service, one or more forms, one or more supporting documents required for applying (or otherwise relevant to the application process), and experiences of other users. The method also includes creating a data package based on results of the searching for information corresponding to the selected consumer service, and presenting the data package associated with the selected consumer service to the user.

Some embodiments provide a system for creating a data package for one or more consumer services. The system includes a server device including a database or database configured to store information related to the one or more consumer services. The information includes workflow information, application procedure(s) for the selected consumer service, one or more forms and one or more supporting documents required for applying (or otherwise relevant to the application process), and experiences of other users. The system also includes a client device including information-retrieving interface configured to display a number of consumer services to a user, and receive a selection of at least one consumer service of the consumer services from the user. The client device also includes a processing module configured to search for information corresponding to the selected consumer service in the database or database. The processing module also creates a data package based on results of the searching for information corresponding to the selected consumer service. The information-retrieving interface presents the user with the data package associated with the selected consumer service.

Some embodiments provide a computer program product embodied on a non-transitory computer readable medium having instructions for creating a data package for one or more consumer services. The computer program product can perform various operations including displaying a number of consumer services through an information-retrieving interface to a user; receiving a selection of at least one consumer service of the plurality of consumer services from the user; and searching for information corresponding to the selected consumer service in a database and database. The information includes workflow information, application procedure(s) for the selected consumer service, one or more forms and one or more supporting documents required for applying (or otherwise relevant to the application process), and experiences of other users. The operations also include creating a data package based on results of the searching for information corresponding to the selected consumer service; and presenting the user with the data package associated with the selected consumer service.

### BRIEF DESCRIPTION OF THE DRAWINGS

FIG. 1 illustrates an exemplary system, in accordance with one embodiment of the present disclosure.

FIG. 2 illustrates another exemplary system, in accordance with another embodiment of the present disclosure.

FIG. 3 illustrates yet another exemplary system including a Multi-Function Device (MFD), in accordance with yet another embodiment of the present disclosure.

FIG. 4 illustrates exemplary structural components of an MFD, in accordance with some embodiments of the present disclosure.

FIG. 5 illustrates an exemplary information architecture for the system of FIGS. 1-3, in accordance with an embodiment of the present disclosure.

FIG. 6 illustrates an exemplary snapshot of an information-retrieving interface, in accordance with an embodiment of the present disclosure.

FIGS. 7A-7C illustrate a flowchart of a method for providing a data package for one or more consumer services to a user, in accordance with some embodiments of the present disclosure.

### DETAILED DESCRIPTION

The following detailed description is made with reference to the figures. Various embodiments are described to illustrate the disclosure, not to limit its scope, which is defined by the claims. Those of ordinary skill in the art will recognize a number of equivalent variations in the description that follows.

As used herein, a Multi-Function Device (MFD) includes a single device that offers a number of traditionally separate functionalities, such as printing, copying, scanning, and faxing. Further, “mobile device” refers to any device that has a wireless connection with a network or components related to the network. The “mobile device” can also be a landline telephone as long as it can communicate with the MFD remotely. The present disclosure includes mobile users such as cell phones, Smartphones, PDAs, and so on. Moreover, an “address” is any identifying information that allows a device to be accessed on a network, such as an IP address or URL, the URL including both long form (including full protocol information, such as “http://”) or short form, beginning with “www” or only a website name, such as “foobar.com”. An “access code” is an identifier capable of designating a specific device, such as an MFD, on a computer network or local computer system. A “telephone number” is an identifier capable of identifying a device or location on any type of telephone network, including traditional voice networks, packet-oriented, etc.

### Overview

Some embodiments relate to methods and systems for creating a data package for one or more consumer services. The systems and methods introduced in this disclosure aid users in effectively and efficiently retrieving information relating to various consumer services. In addition, the disclosed system and methods provide the user with the required amount of information that can help the user to prepare an application packet, or a beneficial amount of information for facilitating the user's preparation of the application packet. The data package creating system can be a single device or a combination of one or more devices for creating data packages or an application packet for different types of consumer services based on user requirement(s). The disclosed system can be implemented as a client server architecture. The client device may include an information-retrieving user interface, and a database may be maintained at the server device. The system may include or otherwise involve more than one server device.

A number of consumer services may be displayed at the information-retrieving interface at the client device. The user can select a consumer service from the displayed options of the consumer services. Then, a data package including all (or a beneficial amount of) information regarding the application process of the consumer service can be prepared and presented to the user accordingly.

### Exemplary Embodiments

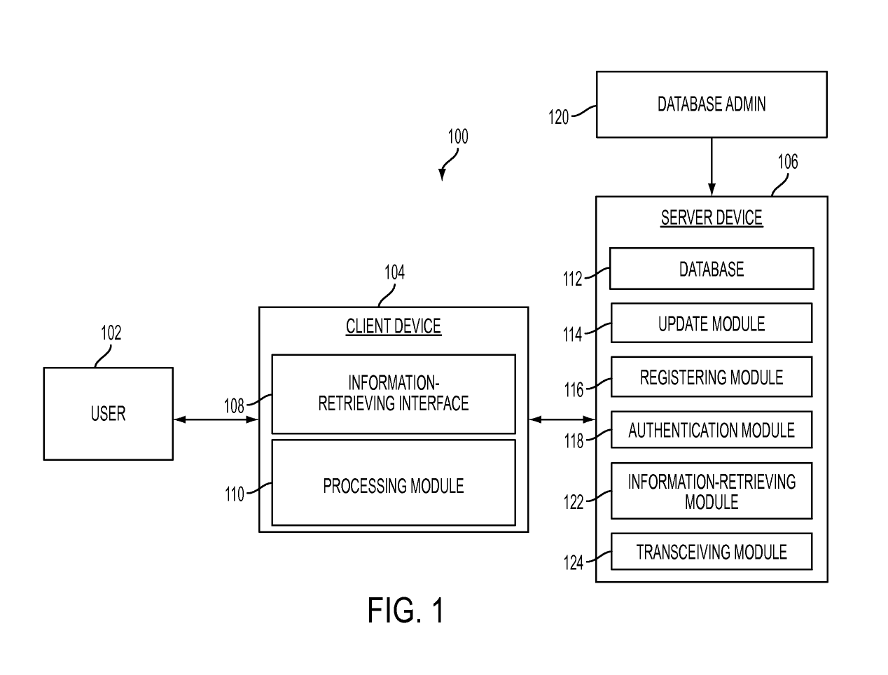

FIG. 1 illustrates an exemplary system 100, in accordance with an embodiment of the present disclosure. As shown, the system 100 includes a client device 104 and a server device 106. A user 102 can interact with the client device 104 via an information-retrieving interface 108. The client device 104 can be any communication device capable of interacting with the server device 106. Examples of the client device 104 may include, but are not limited to, a mobile phone, a personal digital assistant (PDA), a computer, a laptop, a netbook, and so forth. The client device 104 and the server device 106 can interact with each other over wired or wireless technologies. The information-retrieving interface 108 can be an application running on the client device 104. Alternatively, the information-retrieving interface 108 can be associated with a website that can be accessed via an internet browsing application on the client device 104. Examples of the browsing application may include, but are not limited to, Google Chrome™, Internet Explorer™, Mozilla Firefox™, and so forth.

The information-retrieving interface 108 can display a list of consumer services and a number of other options to the user 102 (or consumer) on the client device 104. Examples of the consumer services may include, but are not limited to, banking service(s), credit service(s), driver's license service(s), passport service(s), visa service(s), telephone service(s), cable or satellite television service(s), educational service(s), and so forth. Examples of the options may include, but are not limited to, a ‘login option’, a ‘signup/register option’, a ‘search option’, and so forth. The user 102 can select one or more consumer services from the displayed list of the consumer services. The information-retrieving interface 108 can display one or more questions with multiple levels of dependencies associated with the selected consumer service to the user 102. Then, the user 102 may provide one or more response(s) to the one or more questions accordingly. The information-retrieving interface 108 is also configured to present/display additional questions to the user 102 based on the received response(s). For example, the user 102 may be asked about his/her age, and the response may be 14 years. In this case, the response indicates or implies that he/she is a minor, and then questions related or otherwise relevant to a minor may appear on the information-retrieving interface. The information-retrieving interface 108 is also configured to display tips or special advice to the user 102 based on the experiences of the other users who have had similar experience(s) with the consumer service in past.

The client device 104 also includes a processing module 110 that may determine whether information corresponding to the selected consumer service is available within a database or database 112 of the server device 106. The processing module 110 can also search and retrieve the information corresponding to the selected consumer service from the database 112 of the server device 106. The information can include workflow information, an application procedure for the selected consumer service, one or more forms, and supporting document(s), such as birth certificate, income proof, valid address proof, bank passbooks, etc. of the user 102 (or other users). Further, the application process may differ based on many factors, such as, but not limited to, age of the person, nationality, demographics, etc. For example, to apply for a passport, the supporting documents and forms for a college student residing in a dormitory can be starkly different from those for a child such as a minor with a single parent. The user 102 may not be aware of exactly which forms and documents are required for applying for a passport. Examples of such supporting document requirements (that the user 102 or consumers are usually unaware of) can be: (a) bank statements, if used as address proof, need to have the manager seal and signature for authenticity, for normal passport applications, a minimum of six months of bank statement may be required and for prioritized applications, a minimum of one year's bank statement may be required; (b) if there is any signature mismatched in any of the documents, then a notarized affidavit may be required; (c) if address is not complete in a document, then a notarized affidavit or a supporting document with a verbatim address may be required, for example, in bank passbooks, which are valid address proof documents, banks tend to shorten the address due to space constraints, and so forth. The disclosed system 100 may provide collated information that is required for applying for a consumer service passport to the user 102.

The database 112 may maintain information about application processes of the consumer services, various associated forms, such as application forms, experiences of other users, supported documents of the registered users, details about the registered users (such as the user 102), and so forth. Further, the information can be stored in the database 112 in a machine-readable format, such as by using XML, for use with the information-retrieving interface 108. The processing module 110 may also create a data package including the forms, supporting documents, and other information corresponding to the selected consumer service. The data package associated with the selected consumer service may be presented to the user 102 via the information-retrieving interface 108 and other techniques and devices, such as a display device connected to the client device 104. The processing module 110 can also present personalized advertisements along with the data package to the user 102 via the information-retrieving interface 108. The server device 106 may store the information about various consumer services in form of articles or web pages.

The server device 106 also includes a registration module 116 that may allow the user 102 (or other users) to register/sign-up with the database 112 by providing one or more details, such as, but are not limited to, name, e-mail identity, phone number, age, marital status, and so forth. In some embodiments, the user 102 may also upload or provide one or more supporting documents, such as birth certificate, bank statement, mark sheets, and so forth. A profile may be created for the user 102 based on the registration with the database 112 of the server device 106. After successful registration, the profile of the user 102 may include all the details entered by the user 102, supporting documents, history of information/articles retrieved by the user 102, and so forth.

For registered users, such as the user 102, the processing module 110 may minimize the number of questions, and generate a list of documents required based on the user's personal details. The user 102 can edit the personal details of this profile. In addition, the registration module 116 can proactively remind and allow the user 102 to update the user profile upon the user login.

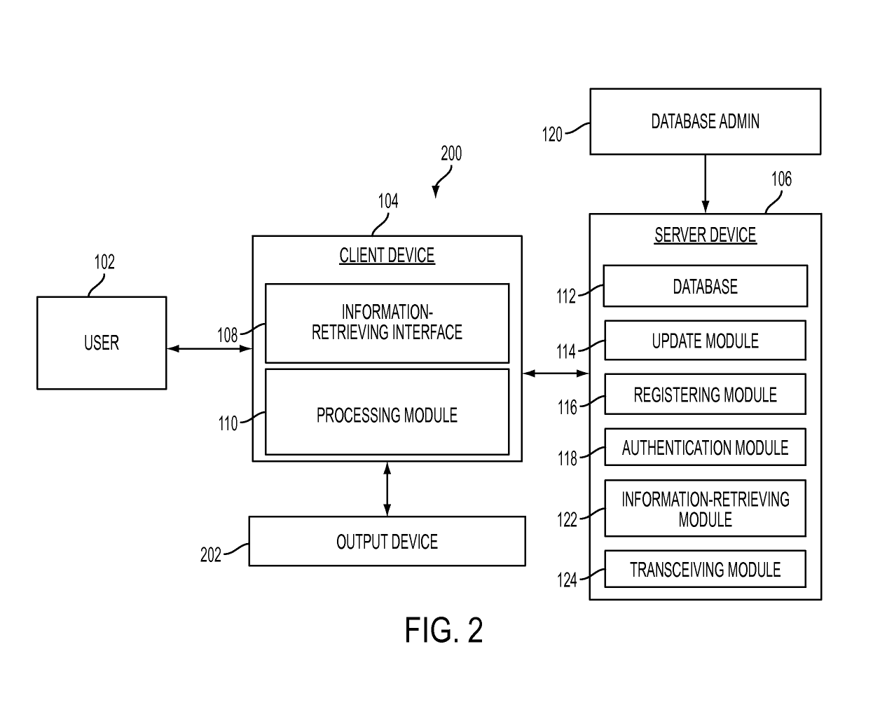

The user 102 can fill out the documents, such as forms, questionnaire(s), etc., digitally and/or may take a print out of the same using an associated printer 202, as shown in FIG. 2. In an embodiment, the client device 104 may also include an associated scanner (not shown) configured to allow a user to scan and/or upload the scanned documents while filling out the forms. Registered users can have their supporting documents stored in the database 112, and thus they may not be required to scan and/or upload the supporting documents every time. Further, for the registered users, the processing module 110 is configured to fill one or more fields of the form(s) based on the profile information available in the database 112. Therefore, the registered users may not be required to fill the form(s) completely and in turn, it can reduce effort of the registered users.

The server device 106 may also include an authentication module 118 configured to authenticate identity of the registered users, such as the user 102, based on one or more login credentials entered by the user 102 at the client device 104. The database 112 may maintain data about all of the registered users. The authentication module 118 may perform a matching of the entered login credentials with data stored in the database 112, and may authenticate the users accordingly.

The server device 106 also includes an update module 114 configured to allow the user 102 or other users to edit, add, delete, or update information stored in the database 112. A database administrator (admin 120) can validate the updating of the database 112. The database admin 120 can moderate and verify the changes made by the users (i.e. user 102). The database 112 is updated after verification by the database admin 120. The system may include more than one database admin 120. The system 100 is shown in FIG. 1 as including one server device 106, but a person skilled in the art will appreciate that the system 100 may include more than one server device 106.

FIG. 2 illustrates another exemplary system 200, in accordance with another embodiment of the present disclosure. As discussed with reference to FIG. 1, the processing module 110 may create the data package, and the information-retrieving interface 108 may display or present/provide the data package to the user 102. The documents or the articles included in the data package may be printed by using a printer 202 attached/connected to the client device 104. For example, the printer 202 may print the application forms, supporting document(s), etc.

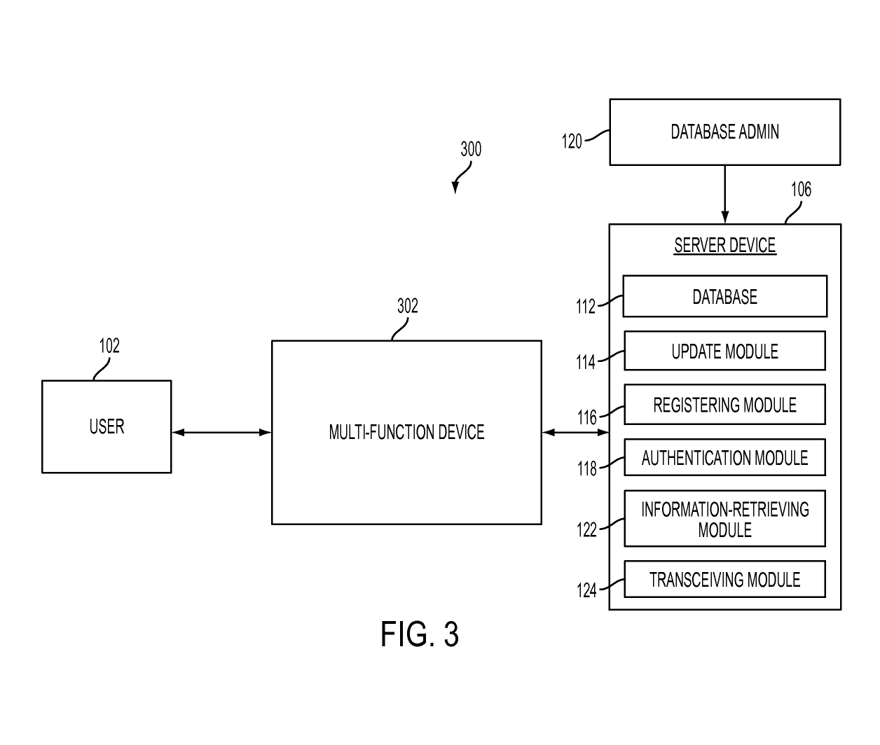

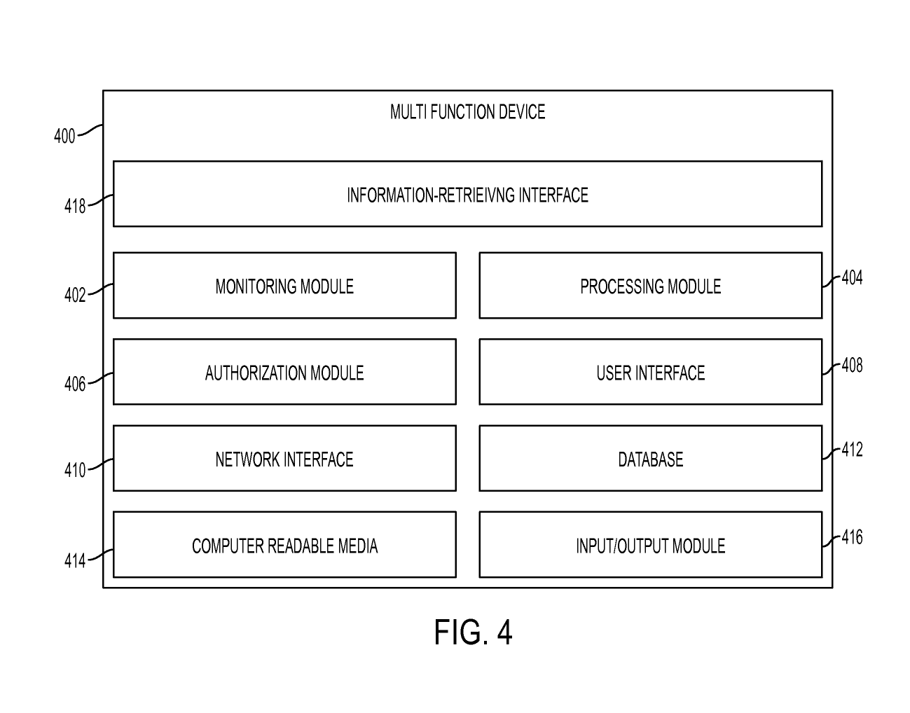

FIG. 3 illustrates another exemplary system 300 including a Multi-Function Device (MFD) 302, in accordance with yet another embodiment of the present disclosure. The multi-function device 302 may be a single device that offers a number of traditionally separate functionalities, such as printing, copying, scanning, and faxing. As shown, the user 102 can access one or more services from the Multi-Function Device (MFD) 302. The MFD 302 can be a device that can perform printing, scanning, copying, or other known, related art or later developed imaging functions. It will be understood that the MFD 302 may perform one, few, or all of the mentioned operations without departing from the scope of the present disclosure. For example, the MFD 302 may be a stand-alone printer or a facsimile machine. Alternatively, the MFD 302 may be a three-in-one printer, scanner, and copier. Further, the MFD 302 may include a suitable interface allowing it to connect with the network and/or mobile devices. These interfaces include a network interface, a cellular interface, and/or a parallel to serial interface. In the illustrated embodiment, the MFD 302 includes the network interface facilitating network connectivity. The structural components of the MFD 302 are explained in detail with reference to FIG. 4.

FIG. 4 illustrates exemplary structural components of a multi-function device 400, in accordance with various embodiments of the present disclosure. As discussed with reference to FIGS. 1-3, the user 102 can interact with the MFD 400 directly or indirectly through the client device 104, which in turn may connect to the remote server device 106, for accessing one or more information. The MFD 400 incorporates into a single device a number of traditionally separate functionalities, such as printing, copying, scanning, and faxing. To make these functionalities available to multiple users, the MFD 400 can be incorporated in a computing network, allowing users to communicate directly with the MFD 400. As shown, an information-retrieving interface 418, which is similar in functionality to the information-retrieving interface 418 of FIG. 1, is integrated within the MFD 400.

To be able to perform the above mentioned functions, the MFD 400 includes a monitoring module 402, a processing module 404, an authorization module 406, a user interface 408, a network interface 410, a database 412, a computer readable media 414, and an input/output (I/O) module 416. Each of these system components is described in detail in the following sections. The network interface 410 allows the MFD 400 to receive and send information to the remote server device 106. The 10 module 416 may take information or may output information to the user 102. The user 102 may submit the first form at the MFD 400 using the 10 module 416. In addition, the 10 module 416 may include a printer for printing the forms. In some instances, the monitoring module 402 may monitor multiple MFD parameters, such as usage, toner availability, performance, paper jam based on requests received from the user 102 or the remote server device 106.

The processing module 404 may receive information from the monitoring module 402 and provide processed information to the user interface 408, the network interface 410 and to the database 412. To this end, the processing module 404 converts the received information into user readable format (in case the information is provided to a user) and database or module readable format (in case information is received from a user). The user 102 may also interact with the MFD 400 through the user interface 408. The user interface 408 can be a graphical user interface (GUI).

If the processing module 404 receives data, such as a filled out form from the user 102 or the remote server device 106, then it may process that information and act upon it, as required. For example, if the received information is a print command, then the processing module 404 retrieves the data to be printed and automatically provides a print command to the MFD 400.

The authorization module 406 regulates access to the MFD 400 based on predetermined user IDs, access codes or preconfigured telephone numbers. For example, each cell phone number of the user 102, or the user 102 may have an associated access code, or unique identity (ID) known only to the user 102. Thus, along with the print command, users may also be prompted to enter an access code or ID for authenticating the user 102 prior to providing access to the MFD 400. For these functions, the database 412 stores profiles of users that includes user information, access codes, telephone numbers, unique IDs, names, preferred printing configurations, preferred paper quality, etc.

The user interface 408 includes multiple modes of communication, such as a simple display, an interactive touch screen display, an audio system, and a combination of a display and audio system. In addition, the user interface 408 may include and provide one or more options to the user 102, for example, for selecting a type of service or form, for submitting form, printing, etc.

The information-retrieving interface 418 may be configured to display a list of consumer services and a number of other options to the user 102. Examples of the options may include, but are not limited to, a ‘login option’, a ‘signup/register option’, a ‘search tab/interface’, ‘update option’, etc. Examples of the consumer services may include, but are not limited to, banking service, driving license service, passport service, visa service, telephone service, and so forth. The user 102 can select one or more consumer services from the displayed list of the consumer services. The information-retrieving interface 418 can also display one or more questions with multiple levels of dependencies associated with the selected consumer service to the user 102. Then, the user 102 may provide one or more response to the one or more questions accordingly. For example, if initially the user's age is asked, and the user enters 15 years as his/her age, then other question(s) related or otherwise relevant to a minor may be displayed to the user. The information-retrieving interface 418 presents/displays additional questions to the user based on the received response. The information-retrieving interface 418 is also configured to display tips or special advice to the user 102 based on the experiences of the other users who have had similar experience(s) with the consumer service in past. For example, the experience(s) of another user who had visited the passport office two days prior to the current user. Such experiences can give the user 102 a better idea and more information about the recent scenario in the consumer service office, such as the passport office.

As discussed with reference to FIG. 1, the processing module 404 may also determine whether information corresponding to the selected consumer service is available within the database 112 of the server device 106 or not. The processing module 404 can also search and retrieve the information corresponding to the selected consumer service from the database 112. The information can include workflow information, an application procedure for the selected consumer service, one or more forms, supporting document(s) such as, birth certificate, income proof, valid address proof, bank passbooks, etc., of the user 102 (or other users). Further, the application process may differ based on age of the person, nationality, demographics, and so forth.

The database 112 may maintain information about all application process(es) of the consumer services, various forms such as application forms, experiences of other users, supporting documents of the users, details about users (such as the user 102), etc. Further, the information can be stored in the database 112 in a machine-readable format, such as by using XML, for use with the information-retrieving interface 108. The processing module 404 may also create a data package including the forms, supporting documents, and other information corresponding to the selected consumer service. The data package associated with the selected consumer service may be presented to the user 102 via the information-retrieving interface 418 and other techniques and devices, such as a display device connected to the client device 104. The processing module 404 is also configured to present personalized advertisements along with the data package to the user 102 via the information-retrieving interface 418.

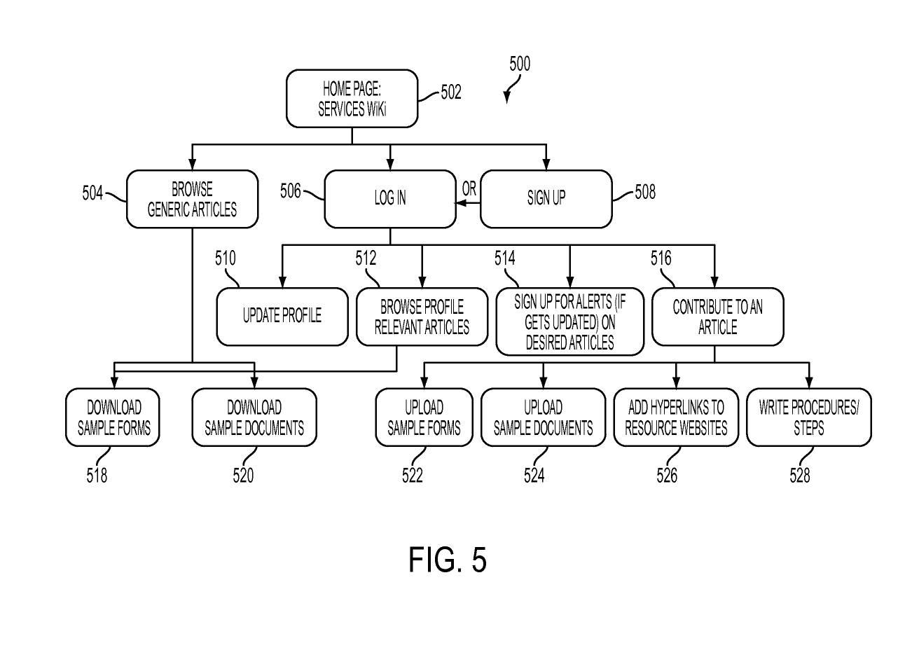

FIG. 5 illustrates an exemplary information architecture 500 for the disclosed system, in accordance with an embodiment of the present disclosure. As discussed with reference to FIGS. 1-4, the user 102 can access the database 112 via an application running on the client device 104, the MFD 302 or via a website. The website can be accessed by typing or entering a uniform resource locator (URL) in a browser application. A Home Page 502 or information-retrieving interface 108 can be displayed to the user at the client device 104 (or the MFD 302). The Home Page 502 may also include a number of consumer service options and other options, such as, but not limited to, ‘Browse generic articles option 504’, ‘Log in option 506’, ‘Sign up option 508’, and so forth.

The user 102 can browse generic articles about various consumer services by selecting the browse generic articles option 504. The user 102 can download sample forms and/or sample documents by selecting an option 518 and 520, respectively.

Various users can register to the database 112 by selecting the Sign up option 508. The unregistered users can enter his/her personal details to register, and in turn to create a profile at the server device 106 based on the entered details. The users can also upload one or more documents during the registration process. Already registered users, such as the user 102, can login to the system by entering his/her login credentials. The disclosed system may authenticate the user based on the login credentials, and then provide access to the database 112 to the user 102. After logging into the system, the user 102 can update his/her profile by selecting the update option 510 or may browse the articles related to his/her profile by selecting the option 512. The user 102 can download sample forms by selecting the option 518, and/or download the sample documents by selecting the option 520.

The system also provides the user 102 with an option 514 to sign-up for alerts regarding some articles or information. For example, the user 102 may receive alerts regarding updates in passport related information. The user 102 can also contribute to an existing article by selecting the option 516. The user 102 can also upload sample forms by selecting an option 522, and can upload sample documents by selecting an option 524. The user 102 can also add hyperlinks to resource websites by selecting an option 526. The user 102 can also write procedures and steps related to the selected consumer service or article by selecting an option 528.

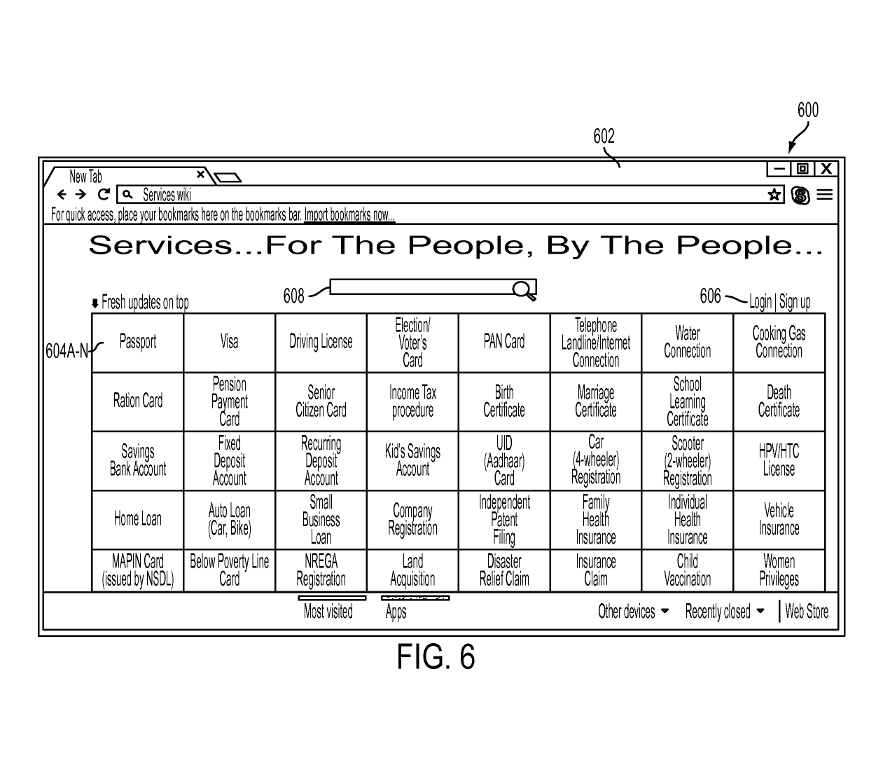

FIG. 6 illustrates an exemplary snapshot 600 of an information-retrieving interface 602, in accordance with an embodiment of the present disclosure. As shown, the information-retrieving interface 602 displays a number of consumer services 604A-N, a search interface/tab 608, a number of options 606, and so forth. The options 606 may include a sign-up option, a login option, and so forth. The user 102 can read articles about the consumer services 604A-N by selecting one or more consumer service from the displayed list of consumer services.

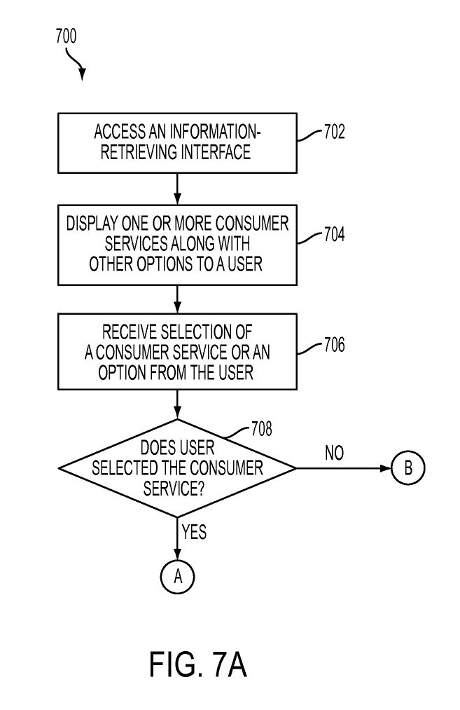

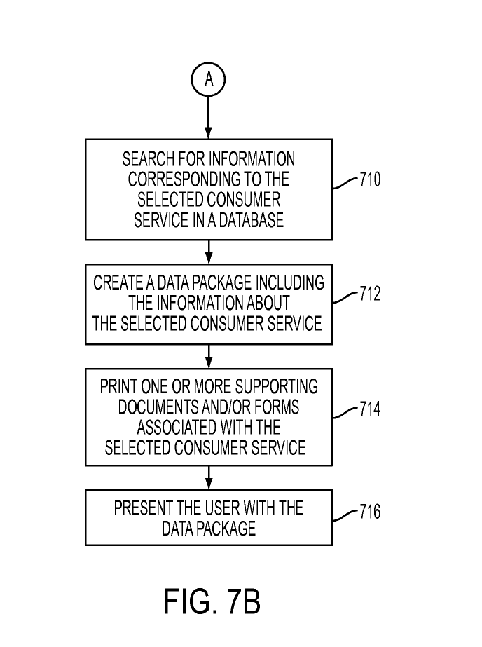

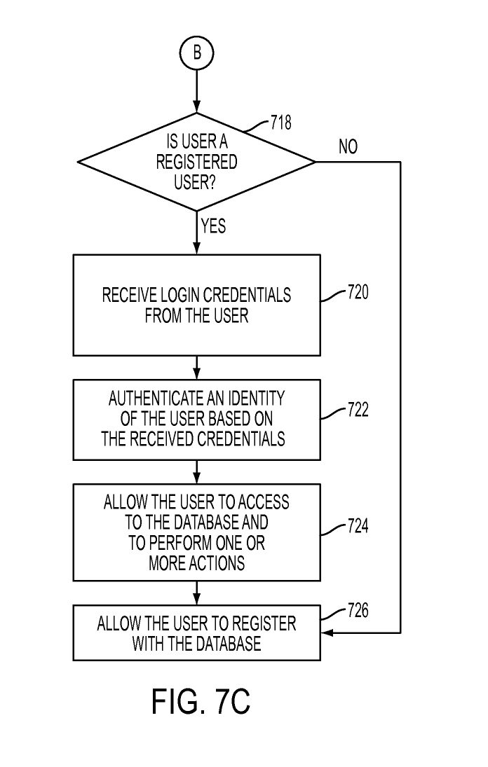

FIGS. 7A-7C illustrate a flowchart of a method 700 for presenting a data package for one or more consumer services, in accordance with some embodiments of the present disclosure. As discussed with reference to FIGS. 1-4, the user 102 can interact with the client device 104 or the MFD 302 for retrieving the information from the database 112 of the server device 106. The client device 104 or the MFD 302 can include the information-retrieving interface 108 or 418, respectively, for displaying information to the user 102 about various consumer services, such as passport service(s), visa service(s), telephone service(s), and so forth. The user 102 can access the information-retrieving interface 108 (or 418) via an application or a website on the client device 104 or the MFD 302. The website can be accessed by entering a URL in a web browsing application, such as internet explorer.

At step 702, the user 102 accesses the information-retrieving interface 108. The user can access the information-retrieving interface 108 via a web browsing application on the client device 104 or the MFD 302. Alternatively, the user can access the information-retrieving interface 108 via an application running on the client device 104 or the MFD 302. Then, at step 704, one or more consumer services are displayed on the information-retrieving interface along with other options to the user 102. The other options can be a search option, a login option, a sign-up option, and so forth.

At step 706, a selection of at least one consumer service or an option is received from the user 102. Then, at step 708, the processing module 110 may check whether the received selection is of the consumer service. If the user 102 selects the consumer service, then step 710 is executed, or else step 718 is executed. At step 710, information corresponding to the selected consumer service is searched in the database 112 by the processing module 110 (or 404). At step 712, the processing module 110 creates a data package including the information about the consumer service. In some embodiments, the data package may include information about the application process in the form of articles, one or more application forms, supporting document requirement(s), and so forth.

Thereafter, at step 714, one or more forms or the supporting documents may be printed or presented to the user. In some embodiments, a printer connected to the client device 104 may print the forms. At step 716, the data package is presented to the user 102 via the information-retrieving interface 108. In some embodiments, the user 102 can read the information available in the data package, and may apply for the selected consumer service at that time. Alternatively, the user 102 may download the data package and use the information of the data package to for the application process later. In some embodiments, the user 102 may be presented with one or more personalized advertisements along with the data package. For example, if the data package includes information about a driver's license, then advertisement(s) of various driver's training schools may be presented to the user along with the data package on the information-retrieving interface 108.

At step 718, it is checked whether the user 102 is a registered user or not. If the user 102 is a registered user, then the process control goes to step 720, or else control goes to step 726. At step 720, the system 100 (or 200 or 300) receives one or more login credentials from the user 102. Then, at step 722, the authentication module 118 of the server device 106 authenticates the identity of the user 102 based on the received login credentials. Thereafter, when the user is an authenticated user, then the user 102 is allowed to access the information from the database 112 and/or to perform one or more actions at step 724. The actions can be to update his/her profile, and to update/add/delete the data of the database. The database administrator (admin) 120 may moderate and verify every change in the database 112.

If the user 102 is not a registered user, then at step 726, the user 102 is presented with an interface to allow the user to register with the database 112. The user 102 can register with the database 112 or the server device 106 by providing one or more details, such as, but not limited to, name, age, e-mail ID, telephone number, and so forth. The user 102 may also upload one or more personal documents at the time of or after registration.

It will be understood that the modules and the databases referred to in the previous sections are not necessarily utilized together in a single document processing system. Rather, these modules are merely exemplary of the various modules that may be implemented within a document processing system. Further, it will be understood that the document processing system and the MFD may include more modules than the ones described in this disclosure without departing from the scope of the present disclosure.

It will be appreciated that several of the above-disclosed and other features and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

What is claimed is:

1. A method for creating a data package for one or more consumer services, the method comprising:
displaying a plurality of consumer services through an information-retrieving interface to a user;
receiving a selection of at least one consumer service of the plurality of consumer services from the user;
searching for information corresponding to the at least one selected consumer service in a database, the information including at least one of workflow information, an application procedure for the at least one selected consumer service, one or more forms, one or more supporting documents relating to the application procedure, and experiences of other users;
creating a data package based on results of the searching for information corresponding to the at least one selected consumer service; and
presenting the data package associated with the at least one selected consumer service to the user.

2. The method of claim 1 further comprising allowing one or more users to register with the database, wherein the user provides one or more pieces of information relating to registration.

3. The method of claim 1 further comprising printing the one or more forms associated with the at least one selected consumer service for the user.

4. The method of claim 1 further comprising:
displaying one or more questions with multiple levels of dependencies associated with the at least one selected consumer service to the user; and
receiving at least one response to the one or more questions from the user, wherein additional questions are presented to the user based on the at least one received response.

5. The method of claim 4, wherein the information-retrieving interface is associated with at least one of an application and a website, which is accessed by a client device.

6. The method of claim 5, wherein the client device is a multi-function device.

7. The method of claim 6 further comprising:
receiving one or more login credentials from the user; and
providing access to the user by authenticating the user based on the received login credentials, wherein the access is provided when the user is registered with the database, and the database is accessed through at least one of the application and the website by the client device.

8. The method of claim 7 further comprising updating the database by one or more users, wherein at least one database administrator validates the updating of the database.

9. The method of claim 1, wherein the information is stored in the database in a machine-readable format for use with the information-retrieving interface.

10. The method of claim 1, wherein the database is stored on at least one remote server.

11. The method of claim 1 further comprising presenting personalized advertisements along with the data package to the user.

12. A system for creating a data package for one or more consumer services, the system comprising:
a server including a database configured to store information relating to the one or more consumer services, the information including at least one of workflow information, an application procedure for the one or more consumer services, one or more forms, one or more supporting documents relating to the application procedure, and experiences of other users; and
a client device including:
an information-retrieving interface configured to:
display the one or more consumer services to a user; and
receive a selection of at least one consumer service of the one or more consumer services from the user; and
a processing module configured to:
search for information corresponding to the at least one selected consumer service in a database; and
create a data package based on results of the searching for information corresponding to the at least one selected consumer service;
wherein the information-retrieving interface presents the user with the data package associated with the selected consumer service.

13. The system of claim 12, wherein the server further comprises a registering module configured to allow a user to register with the database, wherein the user provides one or more pieces of information relating to registration.

14. The system of claim 12 further comprising a printing device configured to print the one or more forms associated with the at least one selected consumer service for the user.

15. The system of claim 12, wherein the information-retrieving interface is associated with at least one of an application and a website, which is accessed by the client device.

16. The system of claim 12, wherein the client device is a multi-function device.

17. The system of claim 12, wherein the information-retrieving interface is further configured to:
display one or more questions with multiple levels of dependencies associated with the at least one selected consumer service to the user; and
receive at least one response to the one or more questions from the user, wherein additional questions are presented to the user based on the at least one received response.

18. The system of claim 17, wherein the server further comprises an update module configured to allow one or more users to update the database, wherein at least one database administrator validates the updating of the database.

19. The system of claim 12, wherein the information is stored in the database in a machine-readable format for use with the information-retrieving interface.

20. The system of claim 12, wherein the processing module is further configured to present personalized advertisements along with the data package to the user.

21. A computer program product embodied on a non-transitory computer readable medium having instructions for creating a data package for one or more consumer services, the computer program product performing the following steps:
displaying a plurality of consumer services through an information-retrieving interface to a user;
receiving a selection of at least one consumer service of the plurality of consumer services from the user;
searching for information corresponding to the at least one selected consumer service in a database, the information including at least one of workflow information, an application procedure for the selected consumer service, one or more forms, one or more supporting documents relating to the application procedure, and experiences of other users;
creating a data package based on results of the searching for information corresponding to the at least one selected consumer service; and
presenting the user with the data package associated with the at least one selected consumer service.

22. The computer program product of claim 20, further comprising providing instructions for registering one or more users with the database, wherein the user provides one or more pieces of information relating to registration.

23. The computer program product of claim 21 further comprising providing instructions for printing the one or more forms associated with the at least one selected consumer service for the user.
